(19) United States
(12) Patent Application Publication
(10) Pub. No.: US 2019/0379819 A1
(43) Pub. Date: Dec. 12, 2019

(54) DETECTION OF MAIN OBJECT FOR CAMERA AUTO FOCUS

(71) Applicant: SONY CORPORATION, Tokyo (JP)

(72) Inventor: Junji Shimada, San Jose, CA (US)

(73) Assignee: SONY CORPORATION, Tokyo (JP)

(21) Appl. No.: 16/006,716

(22) Filed: Jun. 12, 2018

(51) Int. Cl. H04N 5/232; G06T 7/571; G06T 7/73; G06T 7/80; G06K 9/00; G06T 7/246

(52) U.S. Cl. CPC H04N 5/23212; G06T 7/571; G06T 7/74; G06T 2207/30241; G06K 9/00369; G06T 7/248; G06T 2207/20084; G06T 7/80

(57) ABSTRACT

A camera apparatus and method which selects a main object for camera autofocus control. Captured images are input to a convolution neural network (CNN) which is configured for generating pose information. The pose information is utilized in a process of tracking and determining trajectory similarities between the camera trajectory and the trajectory of each of said multiple objects. A main object of focus is then selected as the main object based on which objects maintains the smallest difference in trajectory between camera and object. The autofocus operation of the camera is based on position and trajectory of this main object.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF COMPUTER PROGRAM APPENDIX

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to camera autofocus control, and more particularly to determining a main (principle) object within the captured image upon which camera autofocusing is to be directed.

### 2. Background Discussion

In performing camera autofocusing, it is necessary to know which element of the image is the object which should be the center of focus for the shot, or each frame of a video. For example a photographer or videographer following a sport scene is most typically focused, at any one point in time, on a single person (or group of persons operating together).

Presently methods for determining this main or principle object in a scene, especially one containing multiple such objects (e.g., persons, animals etc.) in motion are limited in their ability to properly discern the object in relation to other moving objects. Thus, it is difficult for a camera to predict (select) the main object for auto focus when a photographer or a videographer tries to track or follow it under difficult scenes containing multiple objects or occlusions.

Accordingly, a need exists for an enhanced method for automatically selecting a main (principle) object from the captured image in the capture stream upon which autofocusing is to be performed. The present disclosure fulfills that need and provides additional benefits over previous technologies.

### BRIEF SUMMARY

A camera apparatus and method to predict the main (principle) object (target) in the field of view despite camera motion and multiple objects. A convolution neural network (CNN) is utilized for obtaining pose information of the objects being tracked. Then multiple object detectors and multiple object tracking are utilized for determining trajectory similarity between a camera motion's trajectory and each object trajectory. The main object is selected based on which trajectory difference measure is the smallest. Thus, the main object is predicted which reflects the camera user's intention by correlating camera motion trajectory with each object trajectory. The present disclosure has numerous uses in both conventional cameras (video and/or still) in the consumer sector, commercial sector and in the security/surveillance sector.

The present disclosure utilizes an entire image for input to a multiple branch, multiple stage convolutional neural network (CNN). It will be appreciated that in machine learning, a convolutional neural network (CNN) is a class of deep, feed-forward artificial neural networks that can be applied to analyzing visual imagery. It should be noted that CNNs use relatively little pre-processing compared to other image classification algorithms. The pose information generated by the CNN is utilized with tracking bounding boxes to estimate intersections over union (IoU) between objects. Trajectory similarities are then determined between the camera and each of the objects. A main focus object is then selected based on which object has the smallest trajectory difference across frames. The camera then utilizes this object, its position at that instant and its trajectory, for controlling the autofocus system.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWING(S)

The technology described herein will be more fully understood by reference to the following drawings which are for illustrative purposes only:

FIG. 1A and FIG. 1B are diagrams of multiple person pose estimation, showing joints being identified with body parts between joints and the use of part affinity fields with vectors for encoding position and orientation of the body parts, as utilized according to an embodiment of the present disclosure.

FIG. 2A through FIG. 2E are diagrams of body pose generations performed by a convolutional neural network (CNN) according to an embodiment of the present disclosure.

FIG. 3 is a block diagram of a convolutional neural network (CNN) according to an embodiment of the present disclosure.

FIG. 4 is a block diagram of an intersection over union (IoU) as utilized according to an embodiment of the present disclosure.

FIG. 5 is a block diagram of a camera system configured for performing main object selection according to an embodiment of the present disclosure.

FIG. 6 is a flow diagram of main object selection within a field of view according to an embodiment of the present disclosure.

### DETAILED DESCRIPTION

1. Introduction.

Toward improving auto-focusing capabilities, the present disclosure selects a main (principle) object with the goal of reflecting the camera operator's intention since they are tracking that object. A multiple branch, multiple stage convolutional neural network (CNN) is utilized which determines anatomical relationships of body parts in each individual, which is then utilized as input to a process for multiple object tracking in which similar trajectories are determined, and dynamic time warping performed in detecting the main object for auto focus. The present disclosure thus utilizes these enhanced movement estimations in an auto focus process which more accurately maintains a proper focus from frame-to-frame as the object is moving.

2. Embodiment: Pose Generation from a CNN

Estimating poses for a group of persons is referred as multi-person pose estimation. In this process body parts belonging to the same person are linked based on anatomical poses and pose changes for the persons.

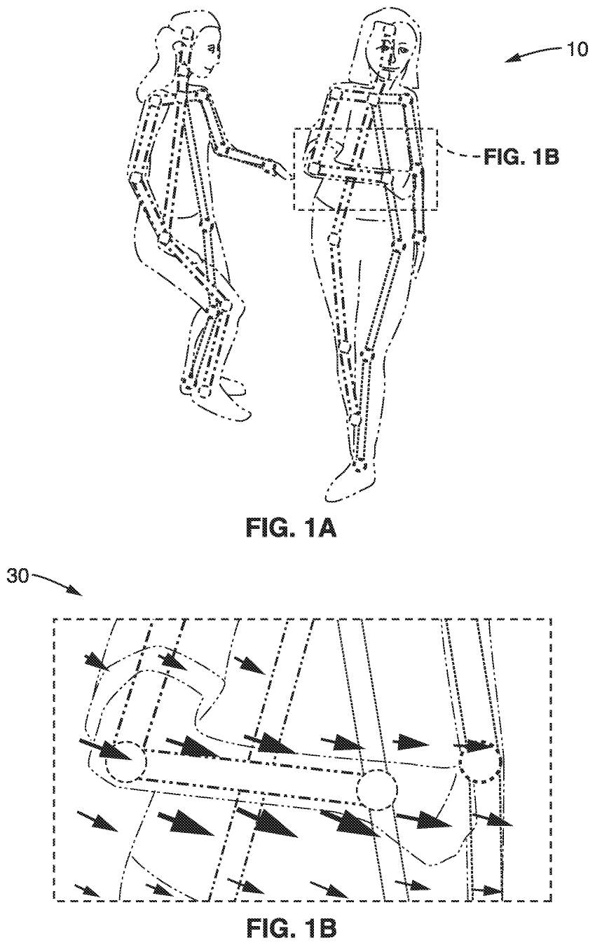

FIG. 1A illustrates an example embodiment 10 in which line segments representing body parts are shown connecting between the major joints of a person. For example, in the figure these line segments are shown extending from each persons' head down to their neck, and then down to their hips with line segments between the hips to the knees and from the knees to the ankles. Also line segments are shown from the neck out to each shoulder, down to the elbows and then to the wrists. These line segments are associated with the body part thereof (e.g., head, neck, upper-arm, forearm, hip, thigh, calve, torso, and so forth).

FIG. 1B illustrates an example embodiment 30 utilizing part affinity fields (PAFs). In the example shown, the right forearm of a person is shown with a line segment indicating the forearm connecting between the right elbow and the right wrist, and depicted with vector arrows indicating the position and orientation of that forearm body part.

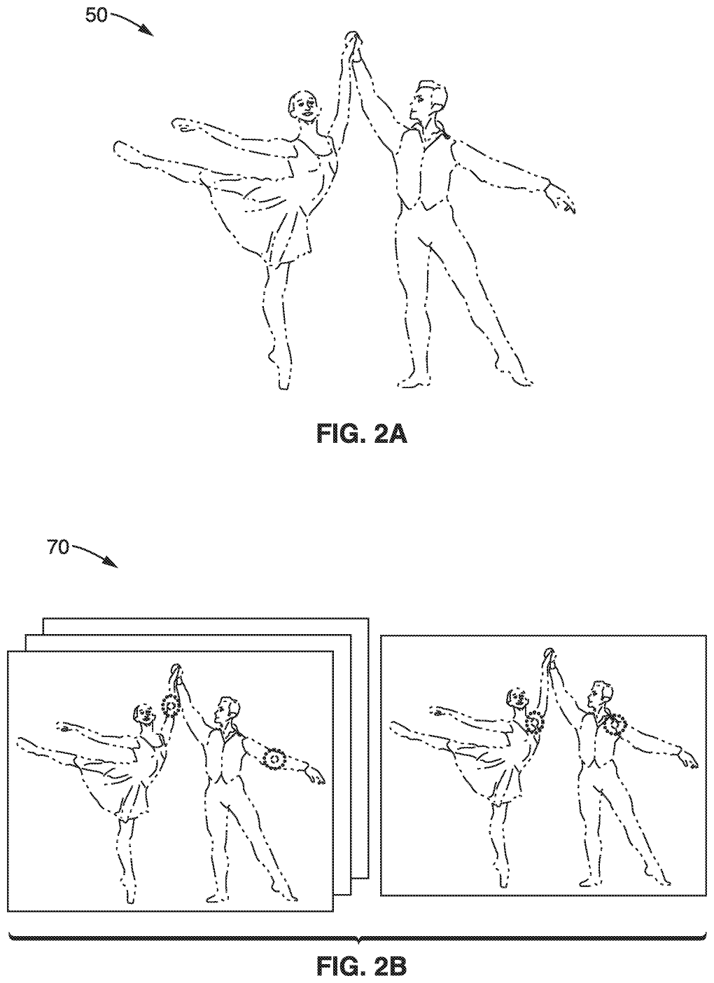

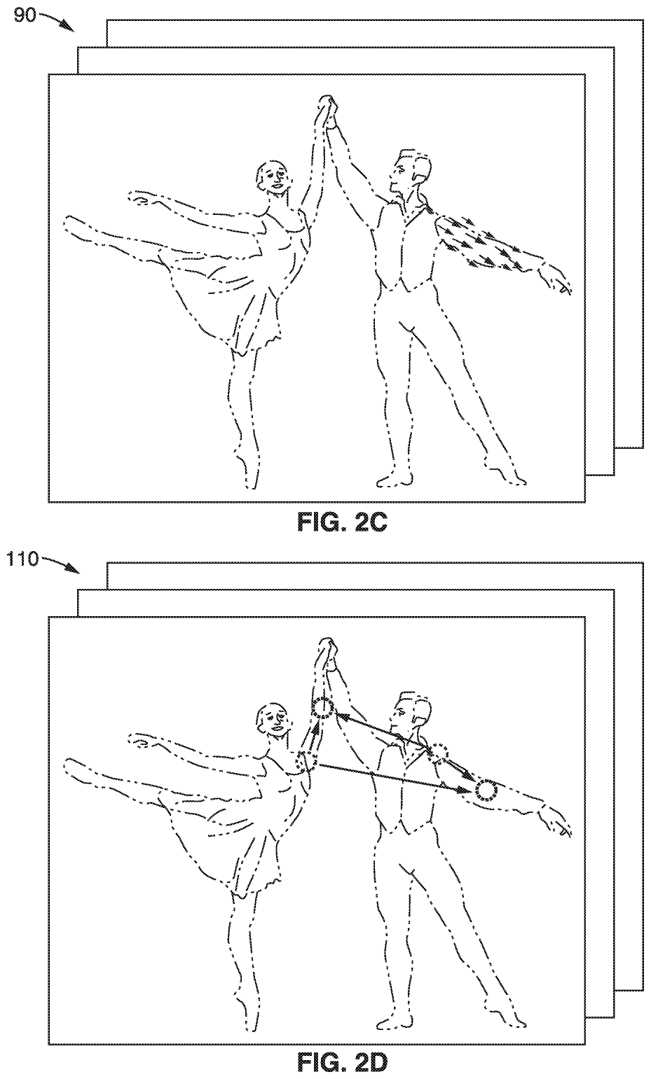

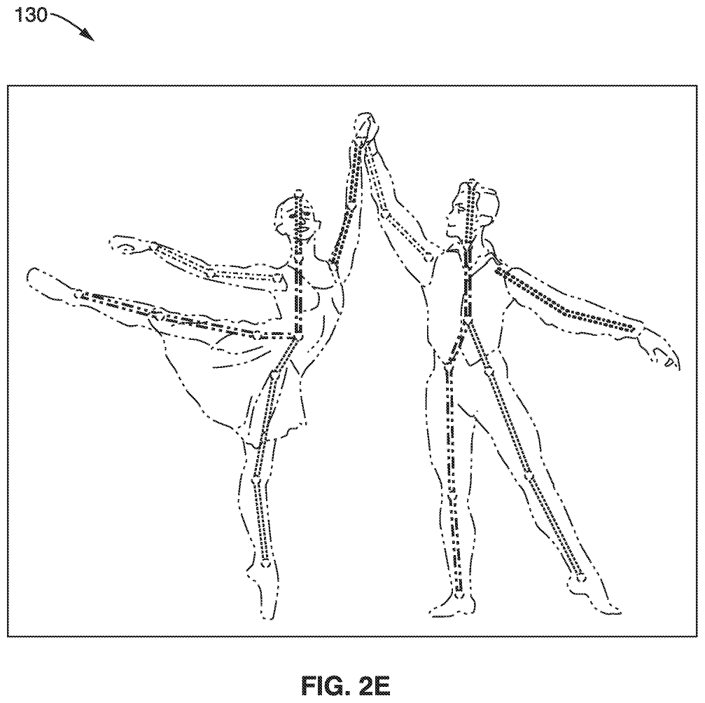

FIG. 2A illustrates an example embodiment 50 receiving an input image, here the input image is shown simply rendered into a line drawing due to reproduction limitations of the patent office. The present disclosure receives an entire image as input for a multiple-branch, multiple-stage convolutional neural network (CNN) which is configured to jointly predict confidence maps for body part detection.

FIG. 2B illustrates an example embodiment 70 showing part confidence maps for body part detection.

FIG. 2C illustrates an example embodiment 90 of part affinity fields and associated vectors.

FIG. 2D illustrates an example embodiment 110 of bipartite matching to associate the different body parts of the individuals within a parsing operation.

FIG. 2E illustrates an embodiment 130 showing example results from the parsing operation. Although the operation is preferably shown with differently colored line segments for each different type of body part, these are rendered here as merely dashed lines segments to accommodate the reproduction limitations of the patent office. Thus, the input image has been analyzed with part affinity fields and bipartite matching within a parsing process to finally arrive at information about full body poses for each of the persons in the image.

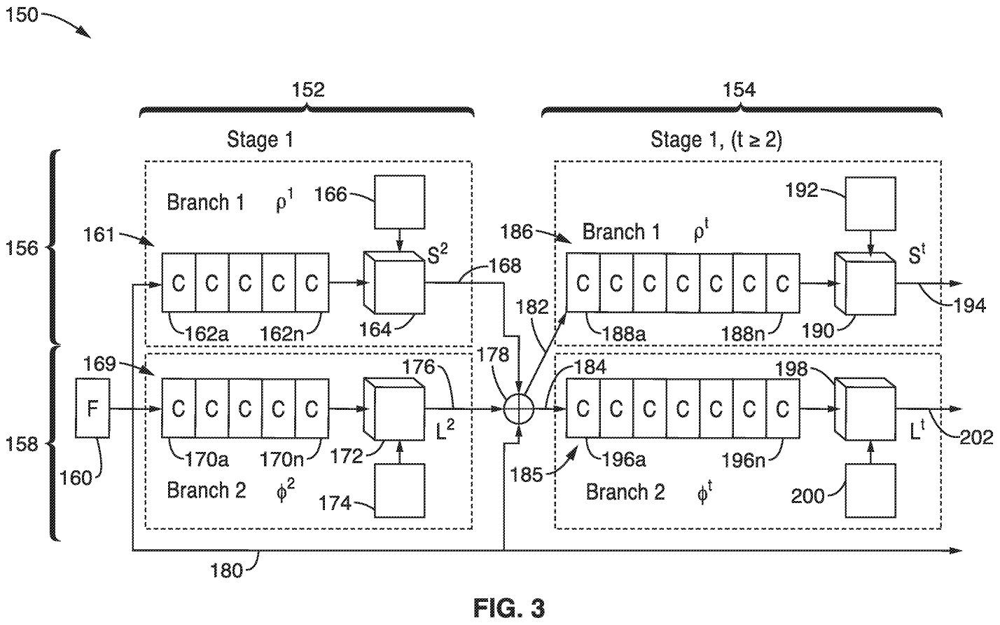

FIG. 3 illustrates an example embodiment 150 of a two-branch, two-stage CNN, as one example of a multiple-branch, multiple-stage, CNN utilized for processing the input images into pose information. An image frame 160 is input to the CNN. The CNN is seen with a first Stage 1 152 through to an n-th Stage 2 154, each stage being shown for example with at least a first branch 156 and a second stage 158. Branch 1 in Stage 1 161 is seen with convolution elements 162a through 162n and output elements 164, 166 outputting 168 to a sum junction 178. Similarly, Branch 2 in Stage 1 169 is seen with convolution elements 170a through 170n and output elements 172, 174 outputting 176 to sum junction 178. In the last stage 154, inputs from sum junction 178 are received 182 into the last stage of Branch 1 186 having convolution elements 188a through 188n and output elements 190, 192 with output 194 representing confidence maps S^{t}. In the last stage of Branch 2 185, inputs from sum junction 178 are received 184 into convolution elements 196a through 196n and output elements 198, 200 with output 202 representing the second branch predicting part affinity fields (PAFs) L^{t}. It should be appreciated that the general structures and configurations of CNN devices are known in the art and need not be described herein in great detail.

It will be noted that neural nets can be implemented in software, or with hardware, or a combination of software and hardware. The present example considers the CNN implemented in the programming of the camera, however, it should be appreciated that the camera may contain multiple processors, and/or utilize specialized neural network processor(s), without limitation.

Each stage in the first branch predicts confidence maps S^{t}, and each stage in the second branch predicts part affinity fields (PAFs) L^{t}. After each stage the predictions from the two branches, along with the image features are concatenated for the next stage.

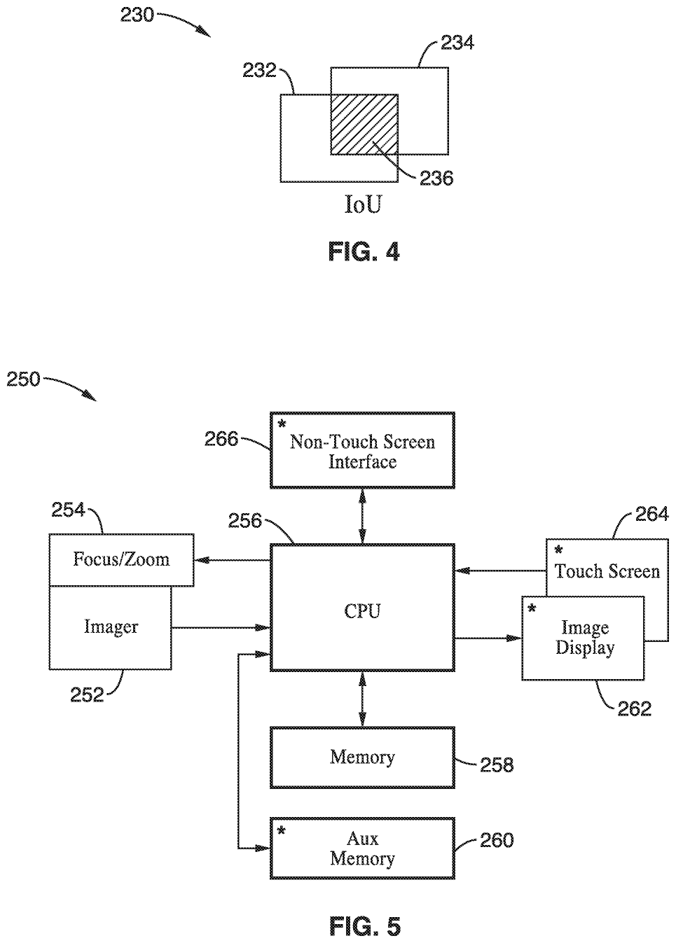

FIG. 4 illustrates an example embodiment 230 of an intersection-over-union (IoU) utilized in selecting the main (principle) object. The figure depicts a first bounding box 232 intersecting with a second bounding box 234, and the intersection 236 therebetween.

FIG. 5 illustrates an example embodiment 250 of an image capture device (e.g., camera system, camera-enabled cell phone, or other device capable of capturing a sequence of images/frame.) which can be configured for performing automatic main object selection as described in this present disclosure. The elements depicted (260, 262, 264, 266) with an asterisk indicate camera elements which are optional in an image capture device utilizing the present technology. A focus/zoom control 254 is shown coupled to imaging optics 252 as controlled by a computer processor (e.g., one or more CPUs, microcontrollers, ASICs, DSPs and/or neural processors) 256.

Computer processor 256 performs the main object selection in response to instructions executed from memory 258 and/or optional auxiliary memory 260. Shown by way of example are an optional image display 262 and optional touch screen 264, as well as optional non-touch screen interface 266. The present disclosure is non-limiting with regard to memory and computer-readable media, insofar as these are non-transitory, and thus not constituting a transitory electronic signal.

3. Embodiment: Determining Trajectory Similarities

A process of multiple object tracking is performed based on the coordinates of the bounding boxes for the targets within the images. The following illustrates example steps of this object tracking process.

(a) Using a recursive state space model based estimation algorithm, for example the Kalman filter, to track bounding boxes with a linear velocity model and also utilize a matching algorithm, for example the Hungarian algorithm, to perform data association between the predicted targets with the intersection over union (IoU) distance as was seen in FIG. 4. It will be noted that IoU is an evaluation metric which can be utilized on bounding boxes.

(b) The state for each bounding box is then predicted using a recursive state space model based estimation (e.g., Kalman filter), as x=[u,v,s,r,\dot{u},\dot{v},\dot{s}]^{T} in which u, v, s and r denote horizontal center, vertical center, area, and aspect ratio for the bounding box, as well as the derivatives of horizontal center (\dot{u}), vertical center (\dot{v}) and area (\dot{s}) with respect to time (T).

(c) A process of associating predicted targets using a matching algorithm (e.g., Hungarian algorithm) is performed with the IoU distance between predicted bounding boxes with the exact bounding boxes at the previous frame. The bounding box having the largest IoU is attached to an identifier (ID) which was attached at the previous frame.

It should be noted that the above steps do not use image information, and only rely on the IoU information and the coordinates of the bounding boxes.

A trajectory similarity process is then performed which involves calculating the total minimum distance between camera trajectory and each object trajectory, followed by a dynamic time warping process. The steps for this process are as follows.

Camera Trajectory: (a) an assumption is made as to camera position in relation to the image frame (camera composition), for example typically this would be considered at the center of the camera composition. (b) Camera distance may be estimated in various ways. In one method a sensor (e.g., gyro sensor) is used to obtain angular velocity whose values are integrated to obtain distance change over that period of time. For example, assuming that the distance between the camera and an object is infinite (in relation to focal length), it can be said that the distance which the camera moves can be calculated from d=f (tan θ) where d is distance, f is focal length, and θ is angle. The angle can be calculated by an integral of the angular velocity for some periods. From the above steps the process according to the present embodiment can estimate the camera position.

Object Trajectory: Coordinates continue to be sequentially connected of each object at the previous frame to those of each object at the current frame based on multiple object detection.

Dynamic Time Warping (DTW): The DTW process is utilized to estimate trajectory similarity (between camera and each object) across frames (over time). In this process DTW calculates and selects the total minimum distance between camera trajectory and each object trajectory at each point in time. It will be noted that smaller differences in trajectory indicate more similar trajectories.

The main object of focus can then be selected as the object whose DTW value is the smallest (most similar to the camera motion) as this is the object that the camera operator is following in this sequence of frames.

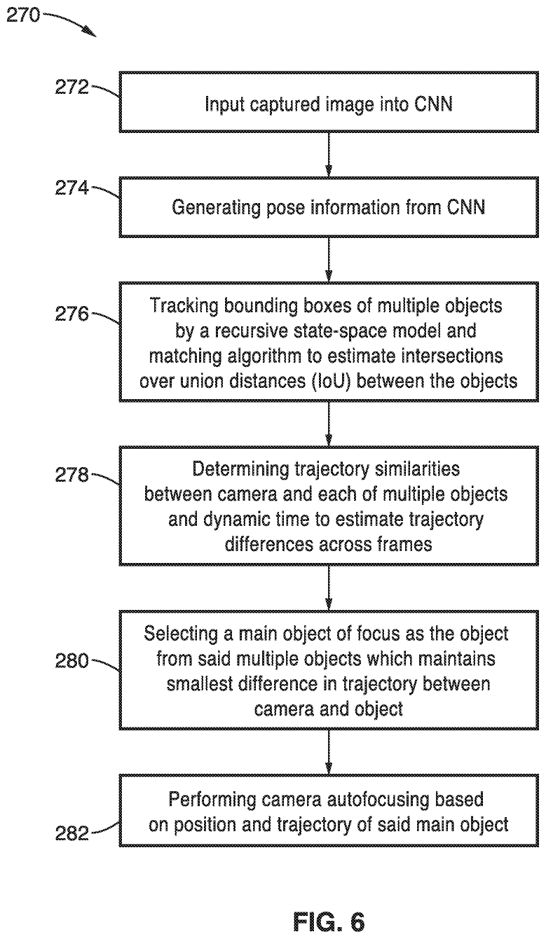

FIG. 6 illustrates an example embodiment 270 summarizing steps performed during main object selection by the camera. At block 272 the image captured by the camera is input to the CNN, which generates 274 pose information. This information is then used in block 276 which tracks bounding boxes of multiple objects by the recursive state-space model and a matching algorithm to estimate intersections over union distances (IoU) between the objects. Then in block 278 trajectory similarities are determined between the camera and each of the multiple objects with dynamic time warping utilized to estimate trajectory differences across frames. In block 280 a main object is selected based on a determination of which object maintains the smallest difference in trajectory between the camera and object. The camera, as per block 282, utilizes this selected object as the basis for performing autofocusing.

4. General Scope of Embodiments

The enhancements described in the presented technology can be readily implemented within various image capture devices (cameras). It should also be appreciated that image capture devices (still and/or video cameras) are preferably implemented to include one or more computer processor devices (e.g., CPU, microprocessor, microcontroller, computer enabled ASIC, DSPs, neural processors, and so forth) and associated memory storing instructions (e.g., RAM, DRAM, NVRAM, FLASH, computer readable media, etc.) whereby programming (instructions) stored in the memory are executed on the processor to perform the steps of the various process methods described herein.

The computer and memory devices were not depicted in each of the diagrams for the sake of simplicity of illustration, as one of ordinary skill in the art recognizes the use of computer devices for carrying out steps involved with main object selection within an autofocusing process. The presented technology is non-limiting with regard to memory and computer-readable media, insofar as these are non-transitory, and thus not constituting a transitory electronic signal.

It will also be appreciated that the computer readable media (memory storing instructions) in these computations systems is “non-transitory”, which comprises any and all forms of computer-readable media, with the sole exception being a transitory, propagating signal. Accordingly, the disclosed technology may comprise any form of computer-readable media, including those which are random access (e.g., RAM), require periodic refreshing (e.g., DRAM), those that degrade over time (e.g., EEPROMS, disk media), or that store data for only short periods of time and/or only in the presence of power, with the only limitation being that the term “computer readable media” is not applicable to an electronic signal which is transitory.

Embodiments of the present technology may be described herein with reference to flowchart illustrations of methods and systems according to embodiments of the technology, and/or procedures, algorithms, steps, operations, formulae, or other computational depictions, which may also be implemented as computer program products. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure (s) algorithm(s), step(s), operation(s), formula(e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, that the terms processor, hardware processor, computer processor, central processing unit (CPU), and computer are used synonymously to denote a device capable of executing the instructions and communicating with input/output interfaces and/or peripheral devices, and that the terms processor, hardware processor, computer processor, CPU, and computer are intended to encompass single or multiple devices, single core and multicore devices, and variations thereof.

From the description herein, it will be appreciated that the present disclosure encompasses multiple embodiments which include, but are not limited to, the following:

1. A camera apparatus, comprising: (a) an image sensor configured for capturing digital images; (b) a focusing device coupled to said image sensor for controlling focal length of a digital image being captured; (c) a processor configured for performing image processing on images captured by said image sensor, and for outputting a signal for controlling focal length set by said focusing device; and (d) a memory storing programming executable by said processor for estimating depth of focus based on blur differences between images; (e) said programming when executed performing steps comprising: (e)(i) inputting an image captured by the camera image sensor into a multiple-branch, multiple-stage convolution neural network (CNN) which is configured for predicting anatomical relationships and generating pose information; (e)(ii) tracking bounding boxes of multiple objects using a recursive state-space model in combination with a matching algorithm to estimate intersections over union distances (IoU) between the multiple objects; (e)(iii) determining trajectory similarities between the camera trajectory and the trajectory of each of said multiple objects by obtaining a camera trajectory and trajectories of each of said multiple objects, followed by a dynamic time warping process to estimate trajectory differences across frames; (e)(iv) selecting a main object of focus as the object from said multiple objects which maintains the smallest difference in trajectory between camera and object; and (e)(v) performing camera autofocusing based on the position and trajectory of said main object.

2. A camera apparatus, comprising: (a) an image sensor configured for capturing digital images; (b) a focusing device coupled to said image sensor for controlling focal length of a digital image being captured; (c) a processor configured for performing image processing on images captured by said image sensor, and for outputting a signal for controlling focal length set by said focusing device; and (d) a memory storing programming executable by said processor for estimating depth of focus based on blur differences between images; (e) said programming when executed performing steps comprising: (e)(i) inputting an image captured by the camera image sensor into a multiple-branch, multiple-stage convolution neural network (CNN), having at least a first branch configured for predicting confidence maps of body parts for each person object detected within the image, and at least a second branch for predicting part affinity fields (PAFs) for each person object detected within the image, with said CNN configured for predicting anatomical relationships and generating pose information; (e)(ii) tracking bounding boxes of multiple objects using a recursive state-space model in combination with a matching algorithm to estimate intersections over union distances (IoU) between the multiple objects; (e)(iii) determining trajectory similarities between the camera trajectory and the trajectory of each of said multiple objects by obtaining a camera trajectory and trajectories of each of said multiple objects, followed by a dynamic time warping process to estimate trajectory differences across frames; (e)(iv) selecting a main object of focus as the object from said multiple objects which maintains the smallest difference in trajectory between camera and object; and (e)(v) performing camera autofocusing based on the position and trajectory of said main object.

3. A method for selecting a main object within the field of view of a camera apparatus, comprising: (a) inputting an image captured by an image sensor of a camera into a multiple-branch, multiple-stage convolution neural network (CNN) which is configured for predicting anatomical relationships and generating pose information; (b) tracking bounding boxes of multiple objects within an image using a recursive state-space model in combination with a matching algorithm to estimate intersections over union distances (IoU) between the multiple objects; (c) determining trajectory similarities between a physical trajectory of the camera and the trajectory of each of said multiple objects by obtaining a camera trajectory and trajectories of each of said multiple objects, followed by a dynamic time warping process to estimate trajectory differences across frames; (d) selecting a main object of focus as the object from said multiple objects which maintains the smallest difference in trajectory between the camera and object; and (e) performing camera autofocusing based on the position and trajectory of said main object.

4. The apparatus or method of any preceding embodiment, wherein said instructions when executed by the processor perform steps for selecting a main object of focus to reflect a camera operator's intention since they are tracking that object with the camera.

5. The apparatus or method of any preceding embodiment, wherein said instructions when executed by the processor are configured for performing said multiple-branch, multiple-stage convolution neural network (CNN) having a first branch configured for predicting confidence maps of body parts for each person object detected within the image.

6. The apparatus or method of any preceding embodiment, wherein said instructions when executed by the processor are configured for performing said multiple-branch, multiple-stage convolution neural network (CNN) having a second branch for predicting part affinity fields (PAFs) for each person object detected within the image.

7. The apparatus or method of any preceding embodiment, wherein said instructions when executed by the processor are configured for performing said recursive state-space model as a Kalman filter.

8. The apparatus or method of any preceding embodiment, wherein said instructions when executed by the processor perform said recursive state-space model based on inputs of horizontal center, vertical center, area, and aspect ratio for a bounding box around each object, as well as derivatives of horizontal center, vertical center and area with respect to time.

9. The apparatus or method of any preceding embodiment, wherein said camera apparatus is selected from a group of image capture devices consisting of camera systems, camera-enabled cell phones, and other image-capture enabled electronic devices.

10. The apparatus or method of any preceding embodiment, wherein selecting a main object of focus is performed to reflect a camera operator's intention since they are tracking that object with the camera.

11. The apparatus or method of any preceding embodiment, further comprising predicting confidence maps of body parts for each object detected by said multiple-branch, multiple-stage convolution neural network (CNN).

12. The apparatus or method of any preceding embodiment, further comprising predicting part affinity fields (PAFs) of body parts for each object detected by said multiple-branch, multiple-stage convolution neural network (CNN).

13. The apparatus or method of any preceding embodiment, wherein utilizing said recursive state-space model comprises executing a Kalman filter.

14. The apparatus or method of any preceding embodiment, wherein said recursive state-space model is performing operations based on inputs of horizontal center, vertical center, area, and aspect ratio for a bounding box around each object, as well as derivatives of horizontal center, vertical center and area with respect to time.

15. The apparatus or method of any preceding embodiment, wherein said method is configured for being executed on a camera apparatus as selected from a group of image capture devices consisting of camera systems, camera-enabled cell phones, and other image-capture enabled electronic devices.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the term “set” refers to a collection of one or more objects. Thus, for example, a set of objects can include a single object or multiple objects.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A camera apparatus, comprising:
(a) an image sensor configured for capturing digital images;
(b) a focusing device coupled to said image sensor for controlling focal length of a digital image being captured;
(c) a processor configured for performing image processing on images captured by said image sensor, and for outputting a signal for controlling focal length set by said focusing device; and
(d) a memory storing programming executable by said processor for estimating depth of focus based on blur differences between images;
(e) said programming when executed performing steps comprising:
(i) inputting an image captured by the camera image sensor into a multiple-branch, multiple-stage convolution neural network (CNN) which is configured for predicting anatomical relationships and generating pose information;
(ii) tracking bounding boxes of multiple objects using a recursive state-space model in combination with a matching algorithm to estimate intersections over union distances (IoU) between the multiple objects;
(iii) determining trajectory similarities between the camera trajectory and the trajectory of each of said multiple objects by obtaining a camera trajectory and trajectories of each of said multiple objects, followed by a dynamic time warping process to estimate trajectory differences across frames;
(iv) selecting a main object of focus as the object from said multiple objects which maintains the smallest difference in trajectory between camera and object; and
(v) performing camera autofocusing based on the position and trajectory of said main object.

2. The apparatus as recited in claim 1, wherein said instructions when executed by the processor perform steps for selecting a main object of focus to reflect a camera operator's intention since they are tracking that object with the camera.

3. The apparatus as recited in claim 1, wherein said instructions when executed by the processor are configured for performing said multiple-branch, multiple-stage convolution neural network (CNN) having a first branch configured for predicting confidence maps of body parts for each person object detected within the image.

4. The apparatus as recited in claim 1, wherein said instructions when executed by the processor are configured for performing said multiple-branch, multiple-stage convolution neural network (CNN) having a second branch for predicting part affinity fields (PAFs) for each person object detected within the image.

5. The apparatus as recited in claim 1, wherein said instructions when executed by the processor are configured for performing said recursive state-space model as a Kalman filter.

6. The apparatus as recited in claim 1, wherein said instructions when executed by the processor perform said recursive state-space model based on inputs of horizontal center, vertical center, area, and aspect ratio for a bounding box around each object, as well as derivatives of horizontal center, vertical center and area with respect to time.

7. The apparatus as recited in claim 1, wherein said camera apparatus is selected from a group of image capture devices consisting of camera systems, camera-enabled cell phones, and other image-capture enabled electronic devices.

8. A camera apparatus, comprising:
(a) an image sensor configured for capturing digital images;
(b) a focusing device coupled to said image sensor for controlling focal length of a digital image being captured;
(c) a processor configured for performing image processing on images captured by said image sensor, and for outputting a signal for controlling focal length set by said focusing device; and
(d) a memory storing programming executable by said processor for estimating depth of focus based on blur differences between images;
(e) said programming when executed performing steps comprising:
(i) inputting an image captured by the camera image sensor into a multiple-branch, multiple-stage convolution neural network (CNN), having at least a first branch configured for predicting confidence maps of body parts for each person object detected within the image, and at least a second branch for predicting part affinity fields (PAFs) for each person object detected within the image, with said CNN configured for predicting anatomical relationships and generating pose information;
(ii) tracking bounding boxes of multiple objects using a recursive state-space model in combination with a matching algorithm to estimate intersections over union distances (IoU) between the multiple objects;
(iii) determining trajectory similarities between the camera trajectory and the trajectory of each of said multiple objects by obtaining a camera trajectory and trajectories of each of said multiple objects, followed by a dynamic time warping process to estimate trajectory differences across frames;
(iv) selecting a main object of focus as the object from said multiple objects which maintains the smallest difference in trajectory between camera and object; and
(v) performing camera autofocusing based on the position and trajectory of said main object.

9. The apparatus as recited in claim 8, wherein said instructions when executed by the processor perform steps for selecting a main object of focus to reflect a camera operator's intention since they are tracking that object with the camera.

10. The apparatus as recited in claim 8, wherein said instructions when executed by the processor are configured for performing said recursive state-space model as a Kalman filter.

11. The apparatus as recited in claim 8, wherein said instructions when executed by the processor perform said recursive state-space model based on inputs of horizontal center, vertical center, area, and aspect ratio for a bounding box around each object, as well as derivatives of horizontal center, vertical center and area with respect to time.

12. The apparatus as recited in claim 8, wherein said camera apparatus is selected from a group of image capture devices consisting of camera systems, camera-enabled cell phones, and other image-capture enabled electronic devices.

13. A method for selecting a main object within the field of view of a camera apparatus, comprising:
(a) inputting an image captured by an image sensor of a camera into a multiple-branch, multiple-stage convolution neural network (CNN) which is configured for predicting anatomical relationships and generating pose information;
(b) tracking bounding boxes of multiple objects within an image using a recursive state-space model in combination with a matching algorithm to estimate intersections over union distances (IoU) between the multiple objects;
(c) determining trajectory similarities between a physical trajectory of the camera and the trajectory of each of said multiple objects by obtaining a camera trajectory and trajectories of each of said multiple objects, followed by a dynamic time warping process to estimate trajectory differences across frames;
(d) selecting a main object of focus as the object from said multiple objects which maintains the smallest difference in trajectory between the camera and object; and
(e) performing camera autofocusing based on the position and trajectory of said main object.

14. The method as recited in claim 13, wherein selecting a main object of focus is performed to reflect a camera operator's intention since they are tracking that object with the camera.

15. The method as recited in claim 13, further comprising predicting confidence maps of body parts for each object detected by said multiple-branch, multiple-stage convolution neural network (CNN).

16. The method as recited in claim 13, further comprising predicting part affinity fields (PAFs) of body parts for each object detected by said multiple-branch, multiple-stage convolution neural network (CNN).

17. The method as recited in claim 13, wherein utilizing said recursive state-space model comprises executing a Kalman filter.

18. The method as recited in claim 13, wherein said recursive state-space model is performing operations based on inputs of horizontal center, vertical center, area, and aspect ratio for a bounding box around each object, as well as derivatives of horizontal center, vertical center and area with respect to time.

19. The method as recited in claim 13, wherein said method is configured for being executed on a camera apparatus as selected from a group of image capture devices consisting of camera systems, camera-enabled cell phones, and other image-capture enabled electronic devices.
